(19) United States
(12) Patent Application Publication
(10) Pub. No.: US 2015/0287090 A1
(43) Pub. Date: Oct. 8, 2015

(54) SYSTEMS, METHODS, AND DEVICES FOR OFFERING PROMOTIONAL MATERIALS TO CUSTOMERS BY MERCHANTS USING A POINT-OF-SALE TERMINAL

(71) Applicant: New Sierra Investments, Haddonfield, NJ (US)

(72) Inventors: Terrence Crowley, Mount Laurel, NJ (US); Amit Chhabra, Mount Laurel, NJ (US)

(21) Appl. No.: 14/681,761

(22) Filed: Apr. 8, 2015

Related U.S. Application Data
(60) Provisional application No. 61/977,051, filed on Apr. 8, 2014.
(60) Provisional application No. 61/977,043, filed on Apr. 8, 2014.

(51) Int. Cl. G06Q 30/02

(52) U.S. Cl. CPC G06Q 30/0268; G06Q 30/0236

(57) ABSTRACT

Embodiments of the present disclosure describe systems, methods, and devices for offering promotional materials to customers by merchants and rendering payment by merchants for third party services using a POS terminal. Such embodiments include configuring an offer by a merchant using a first POS terminal. Further, such embodiments include distributing the offer to a customer through a remote computer system. In addition, such embodiments include receiving, by the customer, the offer using a promotion module on a user device. Moreover, such embodiments include enrolling in the offer using the promotion module on the user device by providing customer-specific information to the promotion module. Such customer-specific information may include, but is not limited to, information regarding a payment card as well as any portable device having a radio frequency (RF) or near field communication (NFC) capability to render payment at a POS device.

### CROSS-REFERENCE TO RELATED APPLICATIONS

The present application claims the benefit under the US law and rules including 35 U.S.C. §119(e) from U.S. Provisional Patent Application Ser. No. 61/977,051 filed on Apr. 8, 2014 the entire contents of which is being incorporated herein by reference.

The present application claims the benefit under the US law and rules including 35 U.S.C. §119(e) from U.S. Provisional Patent Application Ser. No. 61/977,043 filed on Apr. 8, 2014 the entire contents of which is being incorporated herein by reference.

The present application is related to U.S. patent application Ser. No. ______(Attorney Docket No. 5755.118332) titled “Systems, Methods, and Devices for a Common Application Architecture on Multiple Point-of-Sale Hardware Platforms to Support Multiple Applications” filed herewith on the same day as the present application and the entire contents of which is being incorporated by reference.

### BACKGROUND

Many businesses and merchants offer promotions for products and services sold in their establishments. Further, many merchants offer loyalty programs to their customers. For example, a coffee shop may provide a customer with a loyalty card. That is, after each purchase of a coffee the merchant may mark the purchase on the loyalty card (manually or electronically). Upon purchasing a number of coffee drinks (e.g. 5, 10, 20 etc.) the merchant may offer a free coffee drink to the customer. In another example, a merchant may partner with a third party promotion provider and offer a promotion through the third party (and the third party website). Offering promotions through these types of third party providers requires a negotiation of terms between the merchant and the third party promotion provider as well as discussing logistics of the offer. Such negotiations and discussions take time and the offers are rigidly structured (e.g. 50% off a good or service if customers registers in a specific time period). However, many merchants desire to have more flexibility and convenience in offering promotions without dealing with drawn out negotiations and discussions with third party promotion providers.

Accordingly, there is a need for systems, methods, and devices for offering promotional materials to customers by merchants using a point-of-sale (POS) terminal.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention, and explain various principles and advantages of those embodiments.

FIGS. 1A-1C are block diagrams of a system for offering promotional materials to customer or rendering payment to vendors by merchants using a POS device in accordance with some embodiments.

FIG. 2 is block diagram of a POS device for offering promotional materials to customer by merchants in accordance with some embodiments.

FIG. 3 is block diagram of a user device that offers promotional materials to customer by merchants in accordance with some embodiments.

FIG. 4 is block diagram of a remote computing system used in offering promotional materials to customer by merchants in accordance with some embodiments.

FIG. 5 is a flowchart of a method for offering promotional materials to customer or rendering payment, to vendors by merchants using a POS device in accordance with some embodiments.

FIGS. 6A-6B are a block diagrams of a system for offering promotional materials to customer or rendering payment to vendors by merchants using a POS device in accordance with some embodiments.

FIGS. 7A-7B are a flowcharts of methods for rendering payment to vendors by merchants using a POS device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the disclosure. It will be readily understood that, the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts, and accompanying written description. While these details are helpful to explain one or more embodiments, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Embodiments of the present disclosure describe systems, methods, and devices for offering promotional materials to customers by merchants using a point-of-sale (POS) terminal. The term customer may include, but is not limited to, a current customer or a prospective customer. Promotional materials may include discount offers, coupons, or vouchers for a merchant's goods or service. Further, promotional materials may be advertisements of merchant's goods, services, and personnel. The term offer may be used in the present disclosure to include any promotional material. A merchant may be a small business with one or a handful of locations as well as large companies that may include national retailers and chain restaurants.

Such embodiments of the present disclosure include enrolling, by the merchant, into an offer program provided by an operator of a remote computing system using an enrolling point-of-sale device coupled to the remote computing system. Further, accepting the offer program includes generating an offer program account associated with the merchant. Such embodiments also include activating, by the merchant, the offer program account using the enrolling point-of-sale terminal, such that the merchant enters their own payment card data (e.g., a payment card associated with the merchant personally or business) into the POS device for the purposes of enabling the operator of the remote computing system to bill the merchant of the offer services provided. In addition, such embodiments include configuring an offer by a merchant using a first point-of-sale terminal. Further, such embodiments include distributing the offer to a customer through a remote computer system. In addition, such embodiments include receiving, by the customer, the offer using a promotion module on a user device. Moreover, such embodiments include enrolling in the offer using the promotion module on the user device by providing customer-specific information to the promotion module. Such customer-specific information may include, but is not limited to, information regarding a credit card, debit card, charge card, prepaid card, or any other payment card as well as any portable device having a radio frequency (RF) or near field communication (NFC) capability to render payment at a POS device. Also, such embodiments include communicating the customer-specific information to the remote computing system and associating the customer-specific information with the offer. Further, such embodiments include providing the enrolled customer's payment card information with the offer at a second point-of-sale terminal. Note, in some embodiment, the first POS device and second POS device may be the same while in other embodiments the first POS device and second POS device may be different POS devices. In addition, such embodiments include transmitting the customer-specific information to the remote computing system from the second point-of-sale terminal. Moreover, such embodiments include determining that the customer-specific information is associated with the offer and communicating the offer to the second point-of-sale terminal. This may include receiving the validation (message or signal) that the customer's payment card information is associated with the offer as determined by and provided from the remote computing system. Further, such embodiments include redeeming, by the second point-of-sale terminal, the offer to the customer. In some embodiments the remote computing system may be operated by the merchant. However, in other embodiments, the remote computing system and may be the offer service may be operated by a third party promotion and/or payment provider.

Thus, such embodiments may include rendering payment for an offer service to a third party promotion provider from the second point-of-sale terminal to the remote computing system based on a merchant ID assigned to the merchant by the third party promotion provider stored in the second POS device on a recurring basis. In other embodiments, the rendering of payment to the third party promotion provider may be done using a third POS device.

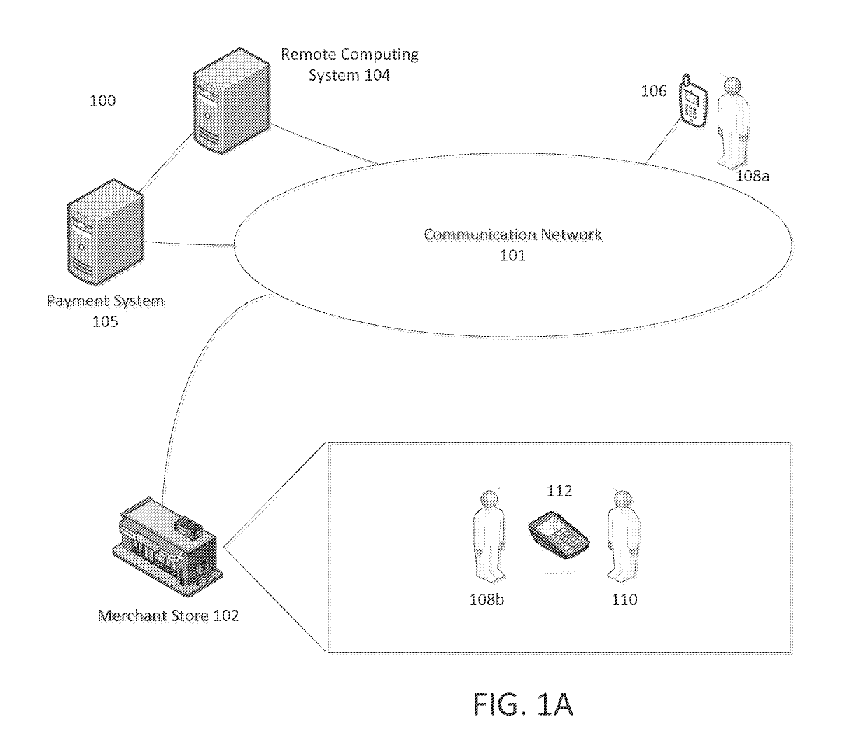

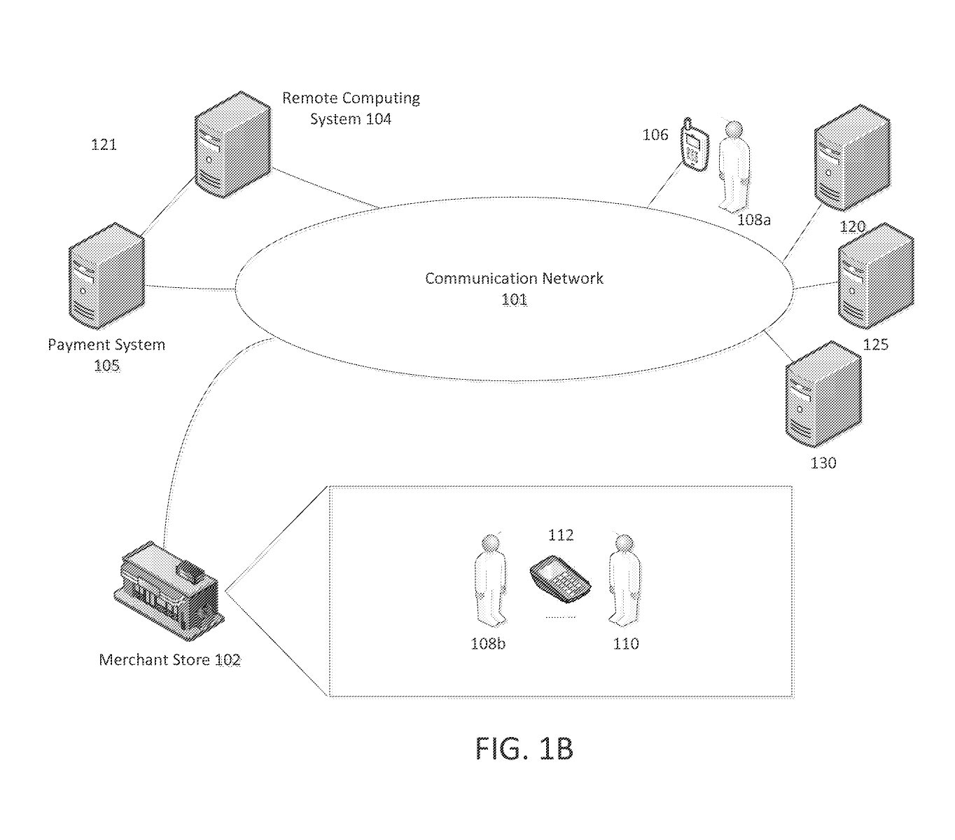

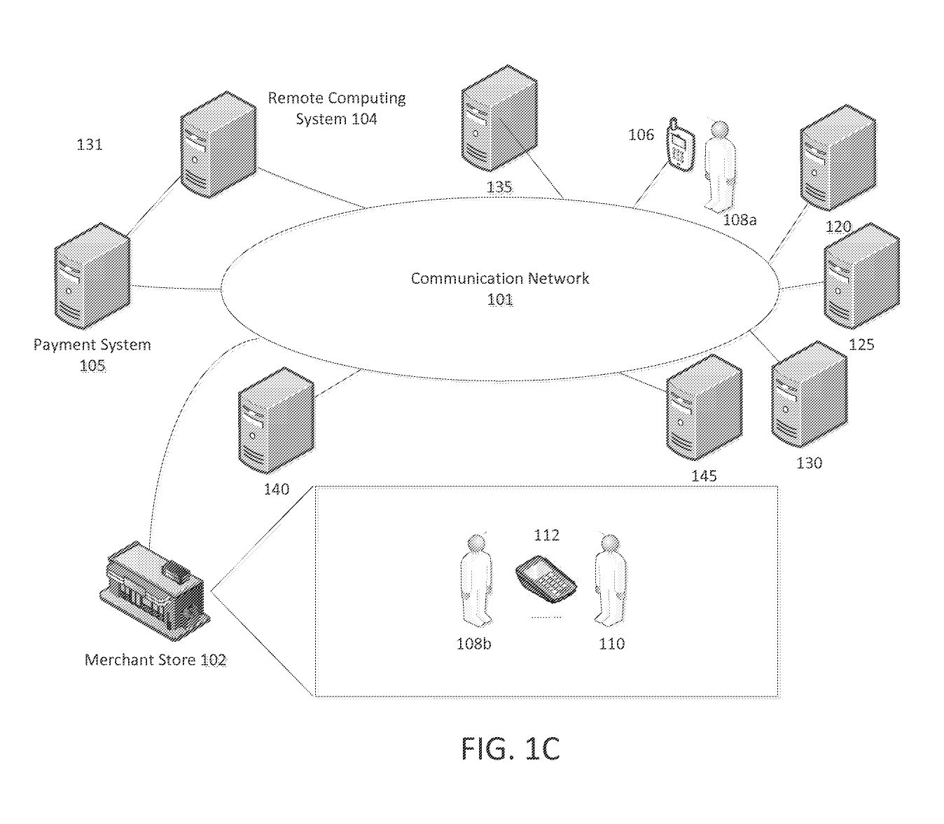

FIG. 1A is a block diagram of system 100 for offering promotional materials to customer by merchants using a POS device in accordance with some embodiments. The system 100 includes a merchant store 102 having a point-of-sale (POS) terminal 112. The merchant store 102 may be a small business, a store from a national retailer (e.g., Target, Walmart, Best Buy, etc.), or a restaurant of a countrywide chain (e.g., Chili's, Olive Garden, etc.). The POS device 112 may be operated by merchant personnel 110. The POS device 112 may be equipped with the payment card reader that may be a magnetic stripe reader, a receiver that detects a smart card, a. RE signal from a payment card, a NFC signal from a payment card, etc.. Such a POS device may include a cash register, a payment card terminal, a smartphone, tablet computer, desktop computer, laptop computer or any computing device that can conduct purchase transactions. Moreover, a payment card may be, but is not limited to, a credit card, debit card, charge card, prepaid card, or any other payment card as well as any portable device having a radio frequency (RF) or near field communication (NFC) capability, or any other wireless or touch technology to render payment at a. POS device.

Further, the POS device 112 may be coupled to a remote computing system 104 over a communication network 101. Moreover, the communication network 101 may be a wireless network, cellular network, landline network, satellite network, or any combination thereof. The merchant personnel 110 may configure an offer or promotion for its customers using the POS device 112 and sends the configured offer to the remote computing system 104. The offer may include discount offers, coupons, or vouchers for a merchant's good or service. Further, offers may include promotional materials that may be advertisements of merchant's goods or services. An example offer may be a discount on a good or service offered by the merchant for a limited time (e.g. 48 hours).

The remote computing system 104 receives the configured offer by the merchant personnel 110 from the POS device 112 over the communication network 101. Further, the remote computing system 104 may be operated by the merchant or may be operated by a third party promotion/offer provider. In addition, the remote computing system 104 processes the configured offer. Such processing may include recording the terms of the offers (e.g. price discount, length, type of goods and/or services discounted, etc.). Further, the remote computing system 104 distributes the configured offer to existing and potential customers through various marketing channels. Examples of marketing channels may include distributing the offer via text message or email message. Existing and potential customers may have provided the merchant with a mobile phone number or email address during a previous purchase or promotional campaign (e.g. “liking” a merchant Facebook page, enrolling for a merchant credit card, etc.). Customer mobile phone numbers and email addresses may be stored in one or more databases coupled to the remote computing system 104. Thus, when the remote computing system 104 receives the configured offer from the merchant, the remote computing system 104 may distribute the configured offer to existing and potential customers based on stored customer mobile phone numbers and email addresses. Thus, the remote computing system 104 may send the configured offer as a text message or as an email message, accordingly.

Further, the remote computing system 104 may distribute the configured offer over social media. In one embodiment, the configured offer may be distributed based on existing and potential customers registered with the merchant social media site (e.g. Facebook page, twitter feed, etc.). In another embodiment, the configured offer may be distributed on social media sites (e.g. Facebook page, twitter feed, etc.) directly by the remote computing system 104 (e.g. by the third party promotion provider). In a further embodiment, the configured offer may be distributed through a mobile, wireless, or web application to a customer. Such a mobile, wireless, or web application may be provided by the merchant or by a third party promotion provider (which may be the operator of the remote computing system 104). In an additional embodiment, a user device 106 of a customer 108a may be detected by the remote computing system 104 over the communication network when the user device 106 may be in the vicinity of the merchant store 102. For example, the user device 106 may be detected via a merchant store's WiFi network. In another example, an (wireless) application on the user device 106 may use GPS location services to detect the location of the user device 106 and process such location information to determine that the user device 106 is in the vicinity of the merchant store 102. Upon detecting the user device 106, the remote computing system 104 may provide the configured offer to the user device 106 by the various methods described herein.

The customer (existing or potential) 108a may receive the configured offer on a user device 105 from the remote computing system 104 over the communication network 101 by the various methods described herein. That is, for example, through a text message or email message, or through a mobile, wireless, or web application. Further, the customer 108a may enroll in the offer by affirmatively accepting the configured offer and providing customer payment card information (e.g. credit card, debit card, charge card, prepaid card, or any other customer-specific information, etc.) to the remote computing system 104 over the communication network 101. Further, the remote computing system 104 receives the customer payment card information and associates the configured offer to the customer payment card information.

At some time in the future, the customer 108b may enter the merchant store 102 and desire to redeem the configured offer. The merchant personnel may request the payment card (e.g. credit card, debit card, charge card, prepaid card, etc.), the customer 108b provided to the remote computing system 104 when enrolling in the offer. Upon rendering the payment card to the POS device 112, the POS device 112 provides the rendered payment card information to the remote computing system 104. Further, the remote computing system 104 validates that the rendered payment card information is associated with the configured offer. Moreover, the remote computing system 104 determines the payment amount for the payment transaction based on the configured offer. In addition, the remote computing system 104 provides such offer validation (by sending the POS device 112 a validation signal or validation message) to the POS device 112, and the remote computing system will complete the redemption of the offer. Upon receiving the offer validation from the remote computing system 104, the POS device 112 will present the redemption details of the configured offer for customer 108b.

In some embodiments, the POS device 112 receives the customer payment card information for a payment transaction and initiates the authorization of the payment transaction. The customer payment card information is communicated to the remote computing system 104. Further, the remote computing system 104 communicates the customer payment card information as well as the payment amount based on the configured offer to the payment system 105. Moreover, the payment system 105 may include an acquirer coupled to a credit card network (e.g. VISA, Mastercard, American Express, Discover, etc.), and the credit card network coupled to the issuer (e.g. a bank) of the customer payment card. The payment system 105 communicates whether the customer payment card is approved for the payment transaction to the remote computing system 104. If so, the remote computing system 104 redeems the configured offer and communicates to the POS device 112 that the payment transaction has been authorized. This communication may also include the redemption details of the configured offer and in some embodiments, may also serve as a validation (message, signal etc.) of the configured offer). Further, the POS device 112 completes the authorization of the payment transaction by displaying or print a receipt that shows that the payment transaction was approved/authorized by the payment system 105. In addition, redemption details of the configured offer may be displayed on the POS device 112 or printed on a receipt for the customer 108b.

Referring to FIG. 1B, in some embodiments where a third party promotion provider assists the merchant in marketing the configured offer to merchant customers (existing or potential) and/or operates the remote computing system 104, the merchant may be able to render payment of such third party promotion provider bills. In such embodiments, a merchant may enroll into an offer program provided by an operator of a remote computing system using an enrolling point-of-sale terminal 112 (or some other POS device) coupled to the remote computing system. Further, enrolling into the offer program includes generating an offer program account associated with the merchant Such embodiments also include the merchant activating the offer program account using the enrolling point-of-sale terminal. The activation of the offer program account includes the merchant rendering the merchant's payment card (e.g. credit card, debit card, charge card, prepaid card, etc.) on the POS device 112. Further, the POS device 112 may be configured upon setup to include the identity or other merchant information. In some embodiments, the merchant may have the merchant identifier (ID) assigned to the merchant by third party promotion provider stored in the POS device 112 thereby allowing the merchant to pay its bill from the third party promotion provider using the POS device 112. Once the merchant payment card information as well as the identity information and merchant ID is provided to the remote computing system 104 operated by the third party promotion provider, the third party promotion provider may charge the merchant payment card account on a recurring basis (e.g. monthly, annually, etc.) for the merchant to pay its bill to the third party promotion provider.

In other embodiments, the remote computing system 104 may provide application programming interfaces (APIs) to other third party service providers (e.g. advertisers, etc.) such that the merchant may render payment to these third party service providers using the POS device by a merchant payment card, including rendering payment on a recurring basis. That is, a merchant ID may be stored in the POS device 112 assigned to a third party service provider. Upon receiving payment transaction information including the merchant ID of the third party service provider, the remote computing system 104 may then examine a database that associated the merchant ID of the third party service provider with the third party service provider and facilitate the billing process between the merchant and the third party service provider (and also charge the third party service provider a service fee for facilitating such a billing process).

FIG. 1B shows embodiments of a system 121 such that third party promotion (or service) provider computing devices (120-130) may be coupled to the remote computing system 104 to allow communication over communication network 101. Thus, the merchant may render payment from the POS device 112 to the third party service provider's computing device (120-130) via the remote computing system 104 on a one-time or recurring basis as described herein. Note, in some embodiments, the third party service provider computing device (120-130) may be included in the remote computing system 104.

In some embodiments of system 121, the remote computing system 104 generates or provides one or more logical connections among a point-of-sale (POS) device, a remote computing system, and one or more third party computing devices 120-130). Each logical connection is associated with a service corresponding to one of third parties. Further, each logical connection is set up, generated, or provided using certain protocols and data communication techniques (e.g. VPN, tunneling, discrete packetization, etc.). As described herein, embodiments of the system 121 allows a merchant to activate an offer program account using the POS device 112. Further, merchant payment card information is entered into the POS device 112 to provide the operator of a remote computing system 104 the ability to bill the merchant for the fees associated with the offer program. In addition, the merchant may configure an offer using POS device 112.

Moreover, embodiments of the system 121 allows for communicating the merchant payment card information between the remote computing system 104 and the POS device 112. Also, embodiments allow for determining a payment account identifier based on the payment card information as well as communicating the payment account identifier between the remote computing system 104 and the POS device 112 and storing the payment account identifier in the POS device 112. In addition, the merchant may render payment for a service to one or more third parties from the POS device 112 to the remote computing system 104 based on a payment account identifier stored in the POS device 112.

FIG. 1C shows embodiments of a system 131 such that third party vendors to the merchant can be paid though the POS device 112 via the remote computing system 104. Third party vendor computing devices (135-145) may be coupled to the remote computing system 104 to allow communication over communication network 101. Thus, the merchant may render payment from the POS device 112 to the third party vendor's computing device (120-130) via the remote computing system 104 on a one-time or recurring basis as described herein. Note, in some embodiments, the third party vendor computing device (135-145) may be included in the remote computing system 104.

In some embodiments of system 131, the remote computing system 104 generates or provides one or more logical connections among a point-of-sale (POS) device 112, a remote computing system 104, and one or more third patty computing devices (135-145). Each logical connection is associated with a service corresponding to one of third parties. Further, each logical connection is set up, generated, or provided using certain protocols and data communication techniques (e.g. VPN, tunneling, discrete packetization, etc.). As described herein, embodiments of the system 121 allows a merchant to activate an account to pay a third party for a service using the POS device 112. Further, merchant payment card information is entered into the POS device 112 to provide the operator of a remote computing system the ability to bill the merchant for the fees associated with the third party.

Moreover, embodiments of system 131 allows for communicating the merchant payment card information between the remote computing system 104 and the POS device 112. In addition, embodiments allow for determining a payment account identifier based on the payment card information. Also, embodiments allow for communicating the payment account identifier between the remote computing system 104 and the POS device 112 and storing the payment account identifier in the POS device 112. Further, embodiments of system 131 allow for placing an order for service by the merchant using POS device 112 and in other embodiments rendering payment by the merchant for the service to the third party from the POS device 112 to the remote computing system 104 based on a payment account identifier stored in the POS device 112.

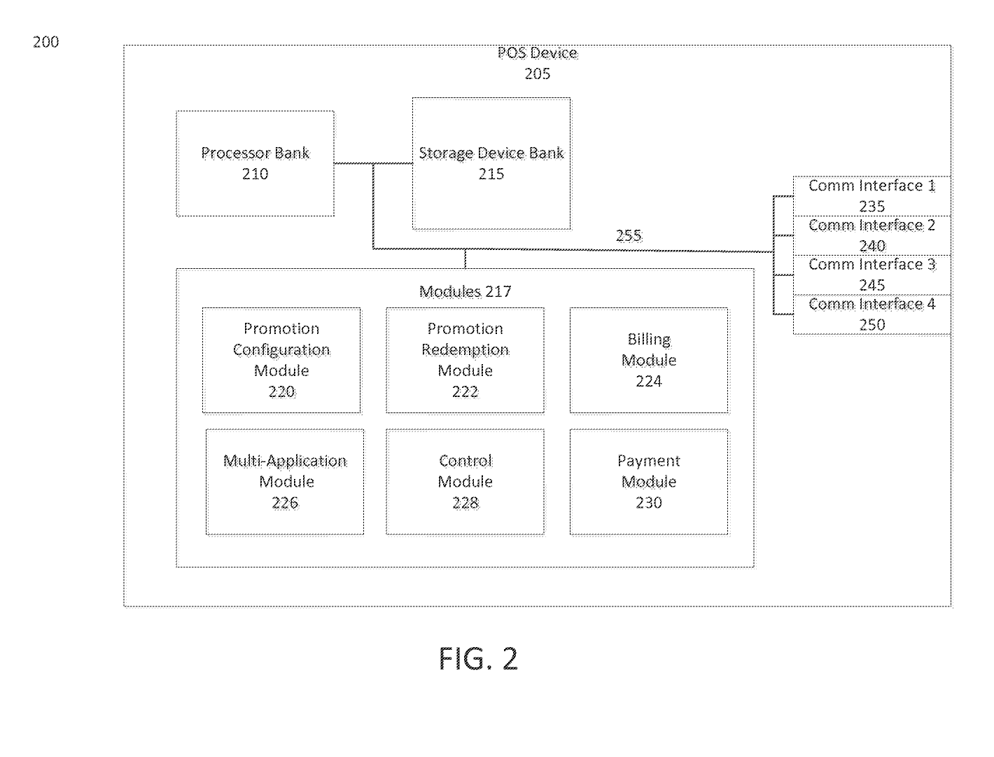

FIG. 2 is block diagram of a POS device 205 for offering promotional materials to customer by merchants in accordance with some embodiments. Such a POS device 205 may be used in a system shown in FIG. 1. The POS device 205 may be equipped with the payment card reader that may be a magnetic stripe reader, a receiver that detects a smart card, a RF signal from a payment card, or a NFC signal from a payment card. Such a POS device 205 may be a cash register, a payment card terminal, a smartphone, tablet computer, desktop computer, laptop computer or any computing device that can conduct purchase transactions. Moreover, a payment card may be, but is not limited to, a credit card, debit card, charge card, prepaid card, or any other payment card as well as any portable device having a radio frequency (RF) or near field communication (NFC) capability, or any other wireless or touch technology to render payment at a POS device 205.

Further, the POS device 205 may include several different components such as a processor bank 210, storage device bank 215, one or more software applications, which may be executed by a processor to form specifically-configured module devices 217, and one or more communication interfaces (235-250). The processor bank 210 may include one or more processors that may be co-located with each other or may be located in different parts of the POS device 205. The storage device bank 215 may include one or more storage devices. Types of storage devices may include memory devices, electronic memory, optical memory, and removable storage media. The one or more modules 217 may include a promotion configuration module 220, promotion redemption module 222, a billing module 224, multi-application module 226, a control module 228, and a payment module 230. The modules 217 may be implemented by the one or more processors in the processor bank 210.

The promotion configuration module 220 allows merchant personnel to configure, on the POS device 205, an offer or promotion for a good or service provided by the merchant to then be distributed to existing and potential customers. The offer may include discount offers, coupons, or vouchers for a merchant's goods or service. Further, offers may include promotional materials that may be advertisements of merchant's goods, services, and personnel. An example offer may be a discount on a good or service offered by the merchant for a limited time (e.g. 4X hours). Once the merchant personnel configure the offer, the configured offer is sent to a remote computing system over the one or more communication interfaces (235-250).

The promotion redemption module 222 allows the POS device 205 to present the redemption of the configured offer for a customer. In one embodiment, the customer, a priori, to redeeming receives the configured offer and accepts or enrolls in the offer by providing a remote computing system with customer payment card information (e.g. credit card, debit card, charge card, prepaid card, etc.), where the remote computing system associates the customer payment card information with the configured offer. To redeem the configured offer at the merchant store, the customer provides the customer payment card information (provided to the remote computing system upon enrolling or accepting the configured offer) to the POS device 205. The POS device 205 sends the customer payment card information to a remote computing system over one of the communication interfaces (235-250). If the customer payment card information is associated with the configured offer, the remote computing system redeems the validated offer, and sends the POS device 205 a validation message or signal, accordingly. The POS device 205 then presents the redemption details of the configured offer for the customer.

The billing module 224 allows a merchant to render payment of bills to a third party promotion provider from the POS device 205. In some embodiments where a third party promotion provider assists the merchant in marketing the configured offer to merchant customers (existing or potential) and/or operates the remote computing system, the merchant may be able to render payment to such third party promotion provider by having the merchant identifier (ID) of the third party promotion provider stored in the POS device 205 thereby allowing the merchant to pay its bill using the POS device 205, where the merchant is entering their payment card into the POS device by swiping, key entering, inserting a chip card, or some contactless method, and the POS device is sending the merchant's payment card details to the remote computing system for the purposes of billing the merchant for the offers services rendered by the remote computing system.

In some embodiments, the billing module 224 provides instructions and information, for the merchant, to enroll into an offer program to an operator of a remote computing system using an enrolling point-of-sale terminal 205 coupled to the remote computing system over a communication network. Further, enrolling into the offer program includes generating an offer program account associated with the merchant by the remote computing system. Further, a merchant may activate the offer program account using the enrolling point-of-sale terminal 205. The activation of the offer program account includes the merchant rendering a merchant payment card (e.g. credit card, debit card, charge card, prepaid card, etc.) on the POS device 205. Further, the POS device 205 may be configured upon setup to include the identity or other merchant information. In some embodiments, the merchant may have the merchant identifier (ID) assigned to the merchant by third party promotion provider operating the remote computing system stored in the POS device 205 thereby allowing the merchant to pay its bill from the third party promotion provider using the POS device 205. Once the merchant payment card information as well as the identity information and merchant ID is provided to the remote computing system operated by the third party promotion provider, the third party promotion provider may charge the merchant payment card account on a recurring basis (e.g. monthly, annually, etc.) for the merchant to pay its bill to the third party promotion provider.

The multi-application module 226 implements different application modules on one POS device 205. For example, the multi-application module 228 may have functions that include accepting payment as well as provide advertisement on a display (not shown) of the POS device 205 to the customer when making a purchase. Another set of application modules that may be coupled to the multi-application module 226 may be configuring an offer as described herein.

The payment module 230 initiates the authorization of a payment transaction based on the configured offer. Upon receiving the customer card information, the payment module 230 communicates the customer card information to a remote computing system which in turn provides the customer card information as well as the payment amount of the payment transaction to a payment system (that includes an acquirer, credit card network, and issuer). Upon receiving authorization of the payment transaction, the remote computing system communicates such authorization to the payment module 230. Further, the remote computing system 104 may provide the promotion redemption module 222 redemption details of the configured offer with the authorization result of the payment transaction. Such redemption details, in some embodiments, may serve as a validation signal or validation message that the customer payment card information is associated with an offer redeemed by the remote computing system.

The control module 228 includes software and hardware functions that assist in performing certain tasks for the POS device 205 such as providing access to a communication link (e.g. wired, wireless, Bluetooth, infra-red, RE, etc.), executing an operating system, managing software drivers for peripheral components, and processing information. In addition, the control module 228 may also include software drivers for peripheral components, user interface computer programs, debugging and troubleshooting software tools. Also, the control module 228 may include an operating system. Such operating systems are known in the art for such POS devices 205 but may also include computer and smartphone operating systems (e.g. Droid, Symbian, Windows mobile, Windows 7, Linux, UNIX, previous version of Windows and MacOS, etc.).

Each of the communication interfaces (235-250) may be software or hardware associated in communicating to other devices. The communication interfaces (235-250) may be of different types that include a user interface, USB, Ethernet, WiFi, WiMax, wireless, optical, cellular, or any other communication interface coupled to a communication network. One or more of the communication interfaces (235-250) may be coupled to a user interface known in the art.

An intra-device communication link 255 between the processor bank 210, storage device bank 215, modules 217, and communication interfaces (235-250) may be one of several types that include a bus or other communication mechanism.

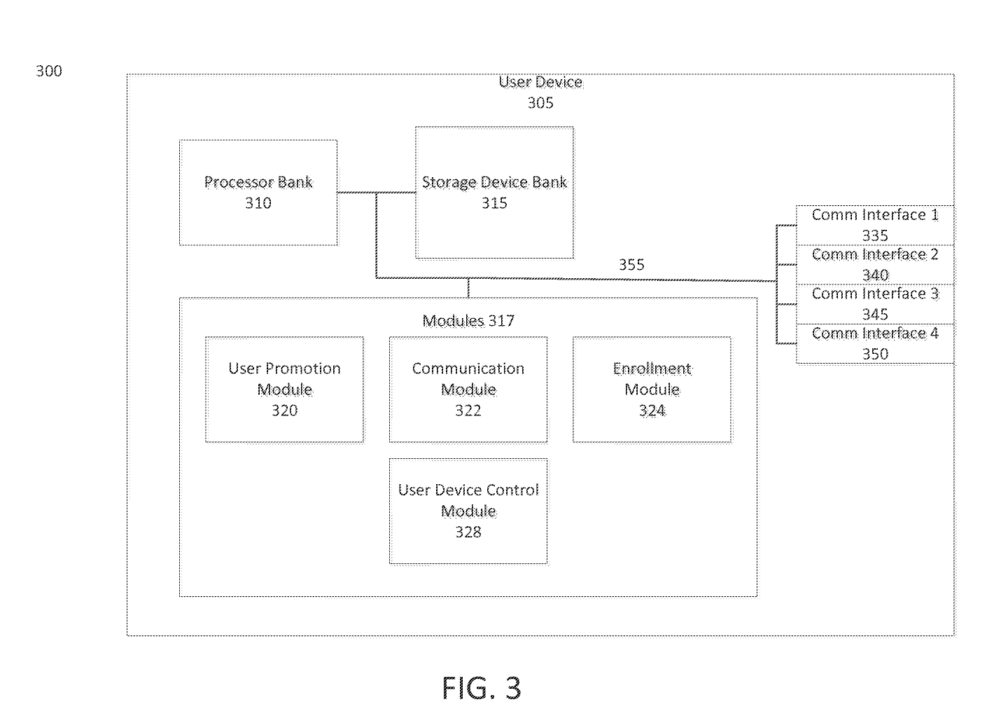

FIG. 3 is block diagram of a user device 305 that offers promotional materials to customer by merchants in accordance with some embodiments. Such a user device 305 may be used in a system shown in FIG. 1 and may be a mobile phone, smartphone, tablet computer, laptop computer, desktop computer, or any other mobile device or other user device (e.g. smart watch, Google glasses, etc.). The user device 305 may include several different components such as a processor bank 310, storage device bank 315, one or more software applications, which may be executed by a processor to form specifically-configured module devices 317, and one or more communication interfaces (335-350). The processor bank 310 may include one or more processors that may be co-located with each other or may be located in different parts of the user device 305. The storage device bank 315 may include one or more storage devices. Types of storage devices may include memory devices, electronic memory, optical memory, and removable storage media. The one or more modules 317 may include a user promotion module 320, communication module 322, an enrollment module 324, and a user device control module 328. The modules 317 may be implemented by the one or more processors in the processor bank 310.

User promotion module 320 allows the user device 305 to receive offers and promotional material from a merchant over a network via a remote computing system. One such offer may have been configured by the merchant using a POS device or device. The offer may include discount offers, coupons, or vouchers for a merchant's good or service. Further, offers may include promotional materials that may be advertisements of merchant's goods, services. An example offer may be a discount on a good or service offered by the merchant for a limited time (e.g. 48 hours). In addition, the remote computing system distributes the configured offer to the user device 305 of existing and potential customers through various marketing channels. Examples of marketing channels may include distributing the offer via text message or email message. Existing and potential customers may have provided the merchant with a mobile phone number or email address during a previous purchase or promotional campaign. Customer mobile phone numbers and email addresses may be stored in one or more databases coupled to the remote computing system. Thus, when the remote computing system receives the configured offer from the merchant, the remote computing system may distribute the configured offer to existing and potential customers based on stored customer mobile phone numbers and email addresses. Thus, the remote computing system may send the configured offer as a text message or as an email message, accordingly.

Further, the remote computing system may distribute the configured offer over social media. In one embodiment, the configured offer may be distributed based on existing and potential customers registered with the merchant social media site (e.g. Facebook page, twitter feed, etc.). In another embodiment, the configured offer may be distributed on social media sites (e.g. Facebook page, twitter feed, etc.) directly by the remote computing system. In a further embodiment, the configured offer may be distributed through a mobile, wireless, or web application on user device 305 to a customer. Further, such a mobile, wireless, or web application may include the user promotion module 320. Such a mobile, wireless, or web application may be provided by the merchant or by a third party (possibly the operator of the remote computing system). In additional embodiment, a user device 305 of a customer may be detected by the remote computing system over a communication network when the user device 305 is in the vicinity of a merchant store. For example, the user device 106 may be detected via a merchant store's WiFi network. In another example, an (wireless) application on the user device may use GPS locations services to detect the location of the user device 305 and process such location information to determine that the user device 305 is in the vicinity of the merchant store. Upon detecting the user device 305, the remote computing system may provide the configured offer to the user device 305 by the various methods described herein.

The communication module 322 allows the user device 305 to receive the configured offer from the remote computing system or send information to the remote computing system to enroll or accept the configured offer (e.g. customer payment card information). The communication module 322 receives and transmits information across a communication network via the communication interfaces (335-350).

Upon the user device 305 receiving the configured offer from the remote computing system over the communication network by the various methods described herein (e.g. through a text message or email message, or through a mobile, wireless, or web application), the customer may enroll in the offer by affirmatively accepting the configured offer and providing customer payment card information (e.g. credit card, debit card, charge card, prepaid card, etc.) to the remote computing system over the communication network via the communication interfaces (335-350). Further, the remote computing system receives the customer payment card information and associates the configured offer to the customer payment card information.

The user device control module 328 includes functions implement software and hardware functions that assist in performing certain tasks for the user device 305 such as providing access to a communication link (e.g. wired, wireless, Bluetooth, infra-red, RF, etc.), executing an operating system, managing software drivers for peripheral components, and processing information. In addition, the user device control module 328 may also include software drivers for peripheral components, user interface computer programs, debugging and troubleshooting software tools. Also, the user device control module 328 may include an operating system. Such operating systems are known in the art for such user devices 305 but may also include computer and smartphone operating systems (e.g. Droid, Symbian, Windows mobile, Windows 7, Linux, UNIX, previous version of Windows and MacOS, etc.).

Each of the communication interfaces (335-350) may be software or hardware associated in communicating to other devices. The communication interfaces (335-350) may be of different types that include a user interface, USB, Ethernet, WiFi, WiMax, wireless, optical, cellular, or any other communication interface coupled to a communication network. One or more of the communication interfaces (335-350) may be coupled to a user interface known in the art.

An intra-device communication link 355 between the processor hank 310, storage device bank 315, modules 317, and communication interfaces (335-350) may be one of several types that include a bus or other communication mechanism.

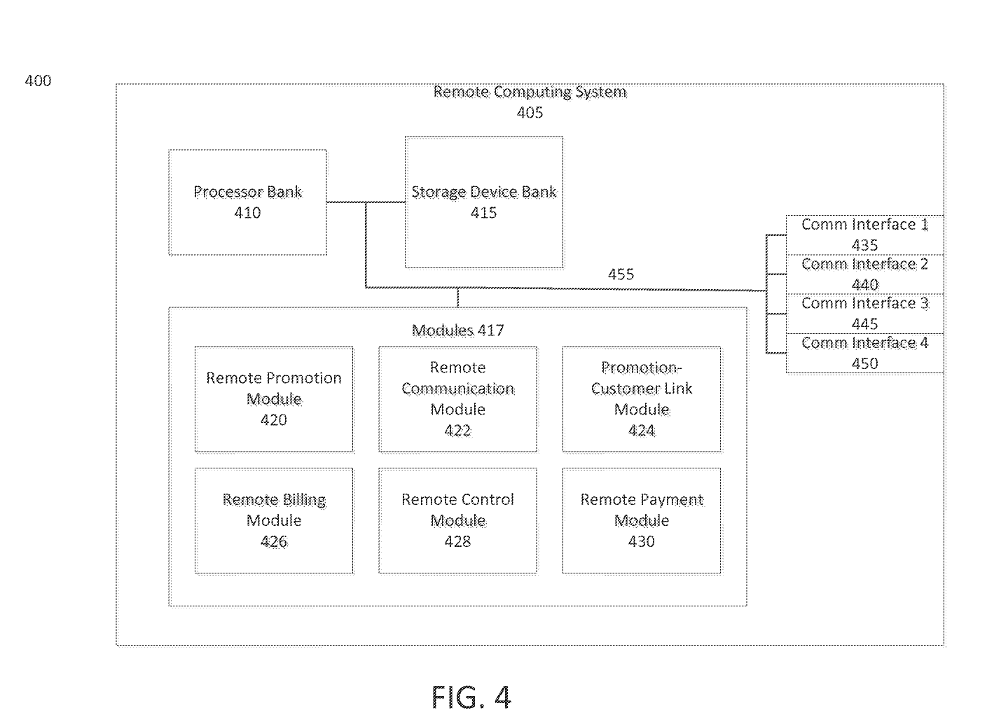

FIG. 4 is block diagram of a remote computing system 405 used in offering promotional materials to customer by merchants in accordance with some embodiments. Such a remote computing system 405 may be used in a system shown in FIG. 1. The remote computing system 405 may include several different components such as a processor bank 410, storage device bank 415, one or more software applications, which may be executed by a processor to form specifically-configured module devices 417, and one or more communication interfaces (435-450). The processor hank 410 may include one or more processors that may be co-located with each other or may be located in different parts of the user device 405. The storage device bank 415 may include one or more storage devices. Types of storage devices may include memory devices, electronic memory, optical memo and removable storage media. The one or more modules 417 may include a remote promotion module 420, remote communication module 422, a promotion-customer link module 424, remote billing module 426, a remote device control module 428, and a remote payment module 430. The modules 417 may be implemented by the one or more processors in the processor bank 410.

The remote computing system 405 may include a database stored in the storage device bank 415 or may be coupled to a database. Further, remote computing system 405 may be part of a computer server system described herein that may include one or more computer servers and one or more databases. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database.

The remote promotion module 420 allows the remote computing system 405 to receive offers and promotional material from a merchant over a communication network via communication interfaces (435-450). One such offer may have been configured by the merchant using a POS device or device. The offer may include discount offers, coupons, or vouchers for a merchant's good or service. Further, offers may include promotional materials that may be advertisements of merchant's goods, services, and personnel. An example offer may be a discount on a good or service offered by the merchant for a limited time (e.g. 48 hours). In addition, the remote computing system distributes the configured offer to one user devices of existing and potential customers through various marketing channels. Examples of marketing channels may include distributing the offer via text message or email message. Existing and potential customers may have provided the merchant with a mobile phone number or email address during a previous purchase or promotional campaign. Customer mobile phone numbers and email addresses may be stored in one or more databases coupled to the remote computing system 405. Thus, when the remote computing system receives the configured offer from the merchant, the remote computing system may distribute the configured offer to existing and potential customers based on stored customer mobile phone numbers and email addresses. Thus, the remote computing system 405 may send the configured offer as a text message or as an email message, accordingly.

Further, the remote computing system 405 may distribute the configured offer over social media. In one embodiment, the configured offer may be distributed based on existing and potential customers registered with the merchant social media site (e.g. Facebook page, twitter feed, etc.). In another embodiment, the configured offer may be distributed on social media sites (e.g. Facebook page, twitter feed, etc.) directly by the remote computing system 405. In a further embodiment, the configured offer may be distributed through a mobile, wireless, or web application on user device to a customer. In an additional embodiment, a user device of a customer may be detected by the remote computing system 405 over the communication network when the user device may be in the vicinity of the merchant store. For example, the user device may be detected via a merchant store's WiFi network. In another example, an (wireless) application on the user device 106 may use GPS locations services to detect the location of the user device and process such location information to determine that the user device is in the vicinity of the merchant store. Upon detecting the user device, the remote computing system 405 may provide the configured offer to the user device by the various methods described herein.

The remote communication module 422 allows the remote computing system 405 to receive the configured offer from a merchant POS device over the communication network via the communication interfaces (435-450). Further, the remote communication module 422 transmits the configured offer to user devices associated with existing and potential customers through various methods described herein over the communication network via the communication interfaces (435-450). In addition, the remote communication module 422 receives customer payment card information from one or more customers that rave accepted and would like to enroll in the configured offer.

Upon receiving a configured offer from the merchant POS device, the promotion-customer link module 424 stores the configured offer in a storage device bank 415 and/or a database. Further, when transmitting the configured offer to existing and potential customers, the promotion-customer link module 424 tracks which customers have been sent the configured offer accordingly. In addition, upon receiving customer payment card information from each customer who accepted and would like to enroll in the configured offer, the promotion-customer link module associates the configured offer with each set of customer payment card information. Moreover, the promotion-customer link module 424 may receive from a merchant POS device customer payment card information and validation request that the customer payment card information is associated with an offer. Further, the promotion-customer link module 424 checks whether the received customer payment card information is stored in the database and associated with a configured offer. If so, the promotion-customer link module sends a validation message or signal to the merchant POS device, Note, in some other embodiments, the merchant POS device used to configure the offer may be the same merchant POS device that requests validation of customer payment card information for the configured offer. However, in other embodiments the merchant POS device used to configure the offer may not be the same merchant POS device that requests validation of customer payment card information for the configured offer.

The remote payment module 430 receives an authorization request as well as customer payment card information and an initial payment amount from a POS device for a payment transaction. The remote promotion module 420 may determine whether the customer payment card information is associated with a configured offer. If so, the remote payment module adjusts the initial payment amount to a payment amount based on the configured offer. Further, the remote computing system 405 communication the customer payment card information and the adjusted payment amount to a payment system (that includes an acquirer, payment card network, and issuer) to obtain authorization of the payment transaction. Upon receiving the authorization of the payment transaction from the payment system, the remote payment module 430 in conjunction with the remote promotion module may provide the POS device with redemption details of the configured offer as well as the authorization of the payment transaction to be presented to the customer. Such redemption details may serve as a validation signal or validation message of that the configured offer is associated with the customer payment card information.

The remote billing module 426 receives instructions and information, from the merchant, to enroll into an offer program provided by an operator of a remote computing system 405 using an enrolling point-of-sale terminal coupled to the remote computing system 405 over a communication network. Further, enrolling into the offer program includes generating an offer program account associated with the merchant by the remote billing module. Further, a merchant may activate the offer program account using the enrolling point-of-sale terminal. The activation of the offer program account includes the merchant rendering a merchant payment card (e.g. credit card, debit card, charge card, prepaid card, etc.) on a POS device. Further, the POS device may be configured upon setup to include the identity or other merchant information. In some embodiments, the merchant may have the merchant identifier (ID) assigned to the merchant by third party promotion provider operating the remote computing system 405 stored in the POS device thereby allowing the merchant to pay its bill from the third party promotion provider using the POS device. Once the merchant payment card information as well as the identity information and merchant ID is provided to the remote computing system 405 operated by the third party promotion provider, the third party promotion provider may charge the merchant payment card account on a recurring basis (e.g. monthly, annually, etc.) for the merchant to pay its bill to the third party promotion provider.

In other embodiment, the remote computing system 405 may provide application programming interfaces (APIs) to other third party service providers (e.g. advertisers, etc.) such that the merchant may render payment to these third party service providers using the POS device by a merchant payment card on a recurring basis. That is, a merchant ID may be stored in the POS device assigned to a third party service provider. Upon receiving payment transaction information including the merchant ID of the third party service provider, the remote computing system 405 may then examine a database that associated the merchant ID of the third party service provider with the third party service provider and facilitate the billing process between the merchant and the third party service provider (and also charge the third party service provider a service fee for facilitating such a billing process).

The remote control module 428 includes software and hardware functions that assist in performing certain tasks for the remote computing system 405 such as providing access to a communication link (e.g. wired, wireless, Bluetooth, infra-red, RF, etc.), executing an operating system, managing software drivers for peripheral components, and processing information. In addition, the remote control module 428 may also include software drivers for peripheral components, user interface computer programs, debugging and troubleshooting software tools. Also, the remote control module 428 may include an operating system. Such operating systems are known in the art for such remote computing systems 405 but may also include computer and smartphone operating systems (e.g. Droid, Symbian, Windows mobile, Windows 7, Linux, UNIX, previous version of Windows and MacOS, etc.).

Each of the communication interfaces (435-450) may be software or hardware associated in communicating to other devices. The communication interfaces (435-450) may be of different types that include a user interface, USB, Ethernet, WiFi, WiMax, wireless, optical, cellular, or any other communication interface coupled to a communication network. One or more of the communication interfaces (435-450) may be coupled to a user interface known in the art.

An intra-device communication link 455 between the processor bank 410, storage device hank 415, modules 417, and communication interfaces (435-450) may be one of several types that include a bus or other communication mechanism.

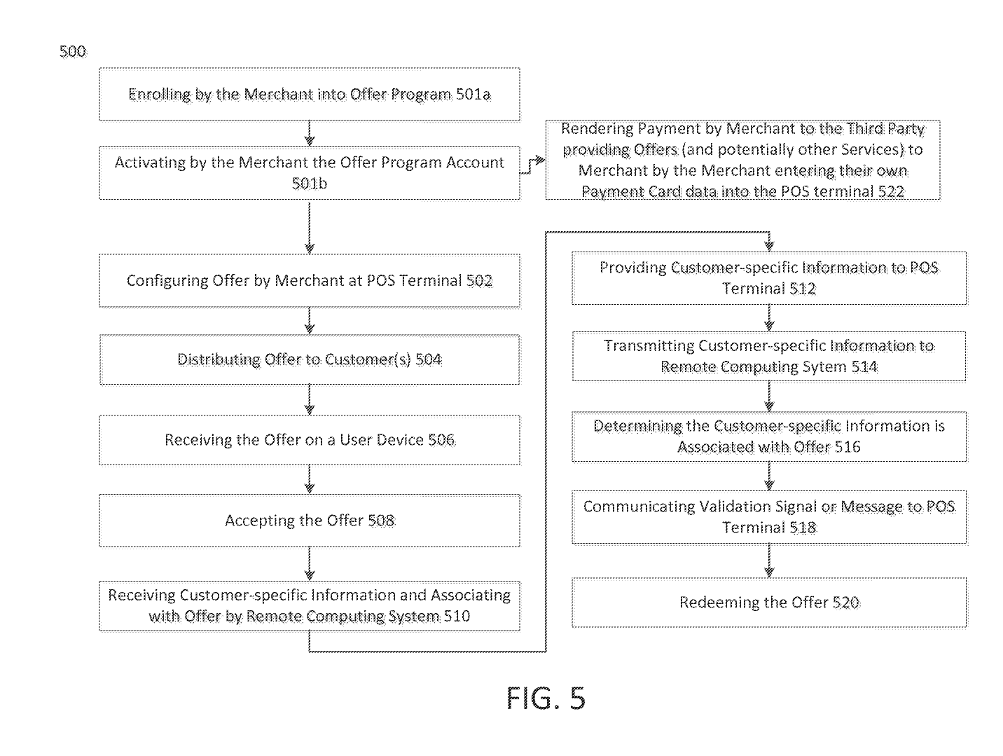

FIG. 5 is a flowchart of a method 500 for offering promotional materials to customer by merchants using a POS device in accordance with some embodiments. Method 500 includes enrolling, by the merchant, into an offer program provided by an operator of a remote computing system using an enrolling point-of-sale terminal coupled to the remote computing system, as shown in block 501a. Enrolling includes generating an offer program account associated with the merchant. Method 500 also include activating, by the merchant, the offer program account using the enrolling point-of-sale terminal, as shown in block 501b. The method 500 includes configuring an offer by a merchant using a first point-of-sale terminal, as shown in block 502. The offer may include discount offers, coupons, or vouchers for a merchant's good or service. Further, offers may include promotional materials that may be advertisements of merchant's goods, services, and personnel. An example offer may be a discount on a good or service offered by the merchant for a limited time (e.g. 48 hours). Further, the method 500 includes distributing the configured offer to a customer through a remote computer system through various marketing channels described herein, as shown in block 504. In addition, the method 500 includes receiving, by the customer, the offer using a promotion module on a user device, as shown in block 506. Moreover, the method 500 includes accepting the offer using the promotion module on the user device by providing customer payment card information (or any other customer-specific information) to the promotion module, as shown in block 508. Also, the method 500 includes receiving the customer payment card information (or any other customer-specific information) at the remote computing system and associating the customer credit card information with the configured offer, as shown in block 510. Further, the method 500 includes providing the enrolled customer card payment card information at a second point-of-sale terminal when the customer is redeeming the configured offer, as shown in block 512. In addition, the method 500 includes transmitting the customer payment card information (or any other customer-specific information) to the remote computing system from the second point-of-terminal as well as a validation request that the customer payment card information is associated with a configured offer, as shown in block 514. Moreover, the method 500 includes determining that the customer credit card information (or any other customer-specific information) is associated with the offer and communicating a validation message or signal to the second point-of-sale terminal, as shown in block 516 and block 518. Further, the method 500 includes redeeming, by the second point-of-sale terminal, the offer to the customer, as shown in block 520. In addition, the method 500 includes rendering payment of offer service to a third party, by the merchant, from the second point-of-sale terminal to the remote computing system based on an merchant ID (or payment identifier associated with payment card data, not necessarily payment card data itself) stored in the second point-of-sale terminal, as shown in block 522. Further details of method 500 has been discussed when describing FIGS. 1-4.

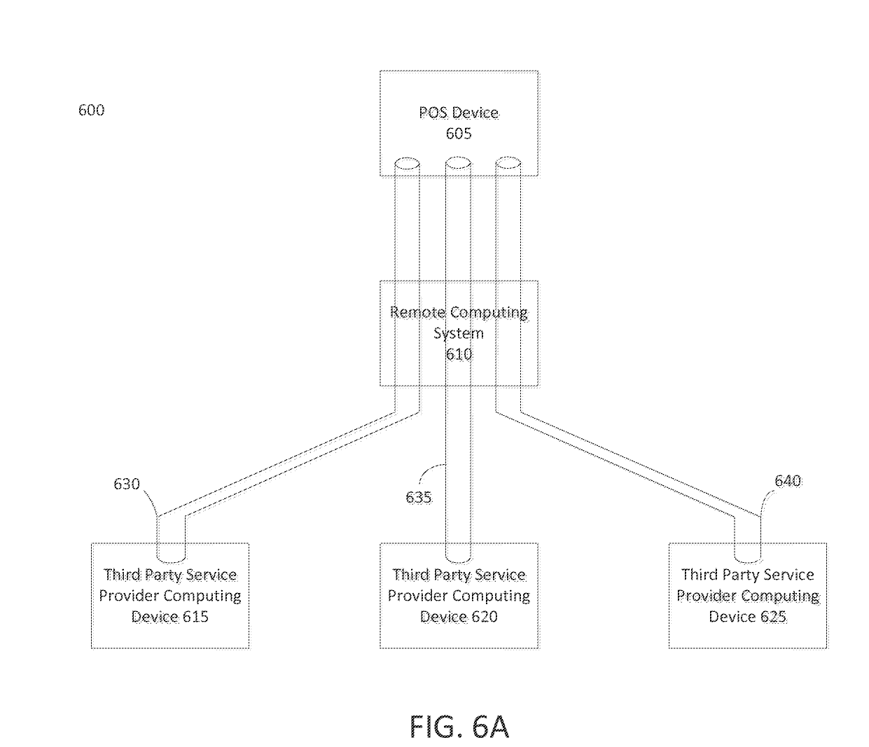

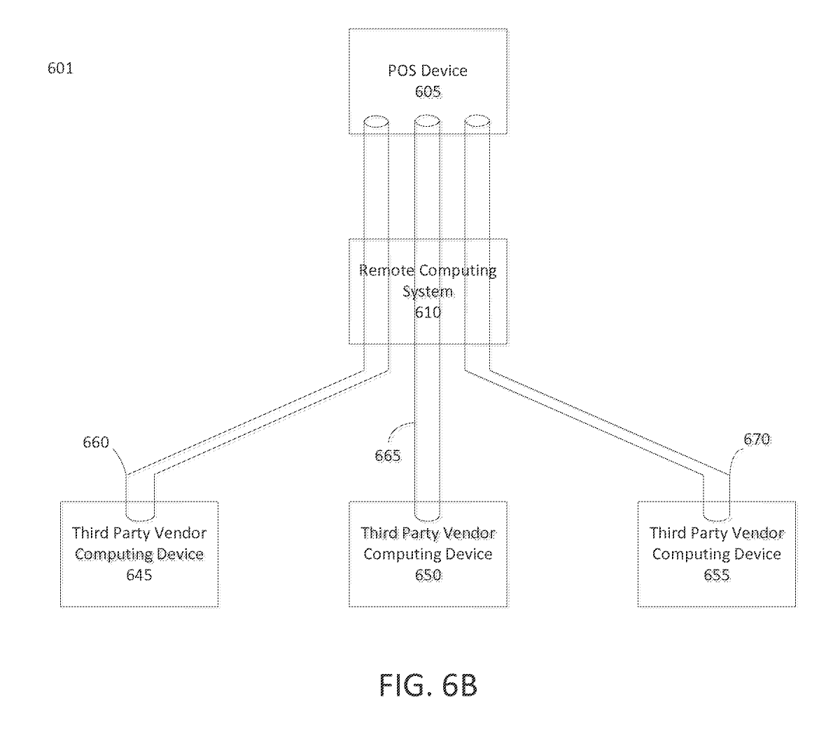

FIGS. 6A-6B are a block diagrams of a system (600 and 601) for offering promotional materials to customer or rendering payment to vendors by merchants using a POS device in accordance with some embodiments. Referring to FIG. 6A, in some embodiments of system 600, the remote computing system 610 generates or provides one or more logical connections (630-640) among a point-of-sale (POS) device 605, a remote computing system 610, and one or more third party computing devices (615-625). Each logical connection (630-640) is associated with a service corresponding to one of third patties. Further, each logical connection is set up, generated, or provided using certain protocols and data communication techniques (e.g. VPN, tunneling, discrete packetization, etc). Note, such a software and/or hardware architecture may be used in other use cases as understood by a person of ordinary skill in the art beyond those described in the pending disclosure.

As described herein, embodiments of the system 600 allows a merchant to activate an offer program account using the POS device 605. Further, merchant payment card information is entered into the POS device 605 to provide the operator of a remote computing system 610 the ability to bill the merchant for the fees associated with the offer program. In addition, the merchant may configure an offer using POS device 605.

Moreover, embodiments of the system 600 allows for communicating the merchant payment card information between the remote computing system 610 and the POS device 605. Also, embodiments allow for determining a payment account identifier based on the payment card information as well as communicating the payment account identifier between the remote computing system 610 and the POS device 610 and storing the payment account identifier in the POS device 605. In addition, the merchant may render payment for a service to one or more third parties from the POS device 605 to the remote computing system 610 based on a payment account identifier stored in the POS device 605.

Referring to FIG. 6B, embodiments of a system 601 such that third party vendors to the merchant can be paid though the POS device 605 via the remote computing system 610. Third party vendor computing devices (645-655) may be coupled to the remote computing system 610 to allow communication over communication network. Thus, the merchant may render payment from the POS device 605 to the third party vendor's computing device (645-655) via the remote computing system 610 on a one-time or recurring basis as described herein. Note, in some embodiments, the third party vendor computing device (645-655) may be included in the remote computing system 610.

In some embodiments of system 601, the remote computing system 610 generates or provides one or more logical connections (660-670) among a point-of-sale (POS) device 605, a remote computing system 610, and one or more third party computing devices (645-655). Each logical connection (660-670) is associated with a service corresponding to one of third parties. Further, each logical connection is set up, generated, or provided using certain protocols and data communication techniques (e.g. VPN, tunneling, discrete packetization, etc.). As described herein, embodiments of the system 601 allows a merchant to activate an account to pay a third party for a service using the POS device 605. Further, merchant payment card information is entered into the POS device 605 to provide the operator of a remote computing system the ability to bill the merchant for the fees associated with the third party.

Moreover, embodiments of system 601 allows for communicating the merchant payment card information between the remote computing system 610 and the POS device 605. In addition, embodiments allow for determining a payment account identifier based on the payment card information. Also, embodiments allow for communicating the payment account identifier between the remote computing system 610 and the POS device 605 and storing the payment account identifier in the POS device 112. Further, embodiments of system 601 allow for placing an order for service by the merchant using POS device 605 and in other embodiments rendering payment by the merchant for the service to the third party from the POS device 605 to the remote computing system 610 based on a payment account identifier stored in the POS device 605.

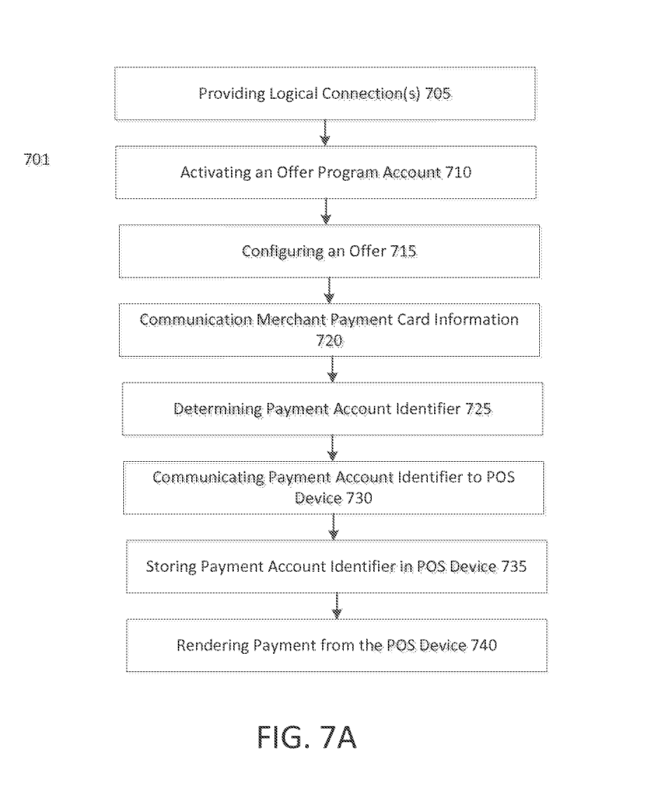

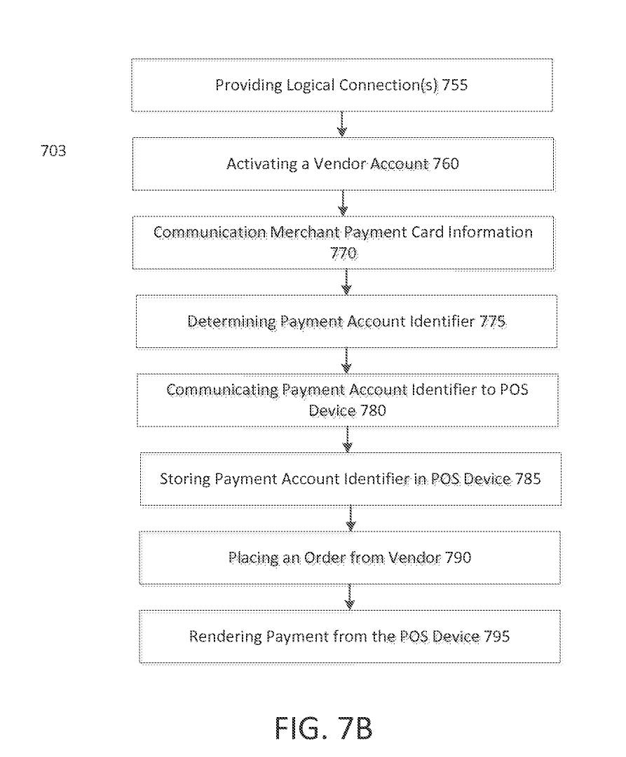

FIGS. 7A-7B are a flowcharts of methods for rendering payment to vendors by merchants using a POS device in accordance with some embodiments. Referring to FIG. 7A, method 701 includes providing one or more logical connections among a point-of-sale (POS) device, a remote computing system, and one or more third party computing devices, as shown in block 705. Each logical connection is associated with a service corresponding to one of third parties. Also, each logical connection is set up, generated, or provided using certain protocols and data communication techniques (e.g. VPN, tunneling, discrete packetization, etc.). Further, the method 701 includes activating, by the merchant, an offer program account using the POS device, as shown in block 710. The merchant payment card information is entered into the POS device to provide the operator of a remote computing system the ability to bill the merchant for the fees associated with the offer program. In addition, the method 701 includes configuring an offer by the merchant using POS device, as shown in block 715.

Moreover, the method 701 includes communicating the merchant payment card information between the remote computing system and the POS device, as shown in block 720. Also, the method 701 includes determining a payment account identifier based on the payment card information, as shown in block 725. Further, the method 701 includes communicating the payment account identifier between the remote computing system and the POS device, as shown in block 730. In addition, the method 701 includes storing the payment account identifier in the POS device, as shown in block 735. Moreover, the method 701 includes rendering payment by the merchant for a service to one or more third parties from the POS device to the remote computing system based on a payment account identifier stored in the POS device, as shown in block 740.

Referring to FIG. 7B, the method 703 includes providing one or more logical connections among a point-of-sale (POS) device, a remote computing system, and one or more third party computing devices, as shown in block 755. Each logical connection is associated with a service corresponding to one of third parties. Also, each logical connection is set up, generated, or provided using certain protocols and data communication techniques (e.g. VPN, tunneling, discrete packetization, etc.). Further, the method 703 includes activating, by the merchant, an account (e.g. vendor account) to pay a third party for a service using the POS device, wherein merchant payment card information is entered into the POS device to provide the operator of a remote computing system the ability to bill the merchant for the fees associated with the third party, as shown in block 760.

In addition, the method 703 includes communicating the merchant payment card information between the remote computing system and the POS device, as shown in block 770. Moreover, the method 703 includes determining a payment account identifier based on the payment card information, as shown in block 775. Also, the method 703 includes communicating the payment account identifier between the remote computing system and the POS device, as shown in block 780. Further, the method 703 includes storing the payment account identifier in the POS device, as shown in block 785.

In addition, the method 703 includes placing an order for service by the merchant using POS device, as shown in block 790. Also, the method 703 includes rendering payment by the merchant for the service to the third party from the POS device to the remote computing system based on a payment account identifier stored in the POS device.

Further, the Appendix shows example screenshots from a display of a POS device as described herein including a POS device that includes a card reader (e.g. credit, debit, prepaid, charge, or any other payment card). The screens depicted in the screenshots shown in the Appendix can be used to configure one or more offers by merchant personnel. The screenshots are of example user interfaces but the present disclosure is not limited by the screenshots shown in the Appendix.

Note, the pending disclosure discusses several different POS devices that implement different functions. However, persons of ordinary skill in the art understand such functions may be implemented within one POS device or implemented across a plurality of POS devices.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
activating, by the merchant, an offer program account using an enrolling point-of-sale device, wherein merchant payment card information is entered into the enrolling POS device to provide an operator of a remote computing system the capability to bill the merchant for the fees associated with the offer program;
configuring an offer by the merchant using a first POS device;
distributing the offer to a customer through the remote computer system.

2. The method of claim 1, further comprising enrolling, the merchant, into an offer program provided by the operator of a remote computing system using the enrolling POS device coupled to the remote computing system wherein enrolling into the offer program includes generating an offer program account associated with the merchant.

3. The method of claim 1, further comprising:
receiving, by the customer, the offer using a promotion module on a user device;
accepting the offer by the customer using the promotion module on the user device by providing customer-specific information to the promotion module;
communicating the customer-specific information to the remote computing system and associating the customer-specific information with the offer.

4. The method of claim 1, further comprising:
providing enrolled customer-specific information at a second POS device;
transmitting the customer-specific information to the remote computing system from the second POS device;
determining whether the customer-specific information is associated with the offer; and
communicating the offer a validation message second POS device.

5. The method of claim 4, further comprising:
receiving a validation message from the remote computing system by the second POS device;
redeeming, by the second POS device, the offer to the customer using the validation message.

6. The method of claim 5, further comprising rendering payment by the merchant for a service to one or more third parties from the second POS device to the remote computing system based on a payment account identifier stored in the second POS device.

7. A method, comprising:
providing one or more logical connections among a point-of-sale (POS) device, a remote computing system, and one or more third party computing devices wherein each logical connection is associated with a service corresponding to at least one of the one or more third parties;
activating, by the merchant, an offer program account using the POS device, wherein merchant payment card information is entered into the POS device to provide the operator of a remote computing system the capability to bill the merchant for the fees associated with the offer program;
configuring an offer by the merchant using POS device.

8. The method of claim 7, further comprising:
communicating the merchant payment card information between the remote computing system and the POS device;
determining a payment account identifier based on the payment card information;
communicating the payment account identifier between the remote computing system and the POS device;
storing the payment account identifier in the POS device.

9. The method of claim 8, further comprising rendering payment by the merchant for a service to one or more third parties from the POS device to the remote computing system based on a payment account identifier stored in the POS device.

10. A method, comprising:
providing one or more logical connections among a point-of-sale (POS) device, a remote computing system, and one or more third party computing devices wherein each logical connection is associated with a service corresponding to at least one of the one or more third parties;
activating, by the merchant, an account to pay a third party for a service using the POS device, wherein merchant payment card information is entered into the POS device to provide the operator of a remote computing system the ability to bill the merchant for the fees associated with the third party.

11. The method of claim 10, further comprising:
communicating the merchant payment card information between the remote computing system and the POS device;
determining a payment account identifier based on the payment card information;
communicating the payment account identifier between the remote computing system and the POS device;
storing the payment account identifier in the POS device.

12. The method of claim 10, further comprising placing an order for service by the merchant using POS device.

13. The method of claim 10, further comprising rendering payment by the merchant for the service to the third party from the POS device to the remote computing system based on a payment account identifier stored in the POS device.
